(19) United States
(12) Patent Application Publication
(10) Pub. No.: US 2019/0180394 A1
(43) Pub. Date: Jun. 13, 2019

(54) METHOD AND SYSTEM FOR EVALUATING COMMERCIAL REAL ESTATE PRICING AND LOCATION BY LEVERAGING TRANSACTION DATA

(71) Applicant: MASTERCARD INTERNATIONAL INCORPORATED, Purchase, NY (US)

(72) Inventor: Debashis Ghosh, Charlotte, NC (US)

(21) Appl. No.: 16/280,325

(22) Filed: Feb. 20, 2019

Related U.S. Application Data
(63) Continuation of application No. 13/935,188, filed on Jul. 3, 2013, now abandoned.

(51) Int. Cl. G06Q 50/16; G06Q 30/02

(52) U.S. Cl. CPC G06Q 50/16; G06Q 30/0278

(57) ABSTRACT

A computer-implemented method for estimating a value for a real property location is provided. The method includes receiving merchant location data for at least one merchant at the computing device, the merchant location data including data identifying a real property location where the at least one merchant is located, receiving historical transaction data associated with the at least one merchant at the computing device, receiving an evaluation request message at the computing device, the evaluation request message including data identifying the at least one merchant, determining a merchant cash flow for the at least one identified merchant based at least on the historical transaction data and a scaling factor, and determining an estimate of the value of the real property location, based at least on the merchant cash flow, the merchant location data, and the historical transaction data.

### BACKGROUND

This description relates to estimating a value for a real property location and, more particularly, to computer systems and computer-based methods for estimating a value for a real property location based at least in part on historical transaction data of at least one merchant located at the real property location.

The value of a piece of a commercial real estate property is at least in part a function of cash flow that can be generated by the property. During the sale of a commercial real estate property, for example a strip mall (also referred to as a “shopping center”), information asymmetry exists between the buyer and the seller. More specifically, the seller has information regarding cash flow generated by the property that the buyer does not have access to. During a negotiation process, a seller may choose to provide certain information regarding cash flow generated by the property. However, validating such information may be difficult for the buyer, as there may not be a third party that can validate the information provided by the seller. Additionally, risks associated with the neighborhood and/or types of goods and services sold at the strip mall may impact the risk of damage to the strip mall and affect insurance premiums. Accordingly, evaluating the pricing and location of commercial real estate may be difficult for a person without the information described above.

### BRIEF DESCRIPTION OF THE DISCLOSURE

In one aspect, a computer-implemented method for estimating a value for a real property location based at least in part on historical transaction data associated with at least one merchant conducting business at the real property location is provided. The method is implemented using a computing device. The method includes receiving merchant location data for the at least one merchant at the computing device, the merchant location data including data identifying a real property location where the at least one merchant is located. The method additionally includes receiving the historical transaction data associated with the at least one merchant at the computing device, receiving an evaluation request message at the computing device, the evaluation request message including data identifying the at least one merchant, determining a merchant cash flow for the at least one identified merchant based at least on historical transaction data and a scaling factor, and determining the estimate of the value of the real property location, based at least on the merchant cash flow, the merchant location data, and the historical transaction data.

In another aspect, a computing device for estimating a value for a real property location based at least in part on historical transaction data associated with at least one merchant conducting business at the real property location is provided. The computing device includes a memory device and a processor coupled to the memory device. The computing device is configured to receive merchant location data for the at least one merchant, the merchant location data including data identifying a real property location where the at least one merchant is located, receive the historical transaction data associated with the at least one merchant, receive an evaluation request message, the evaluation request message including data identifying the at least one merchant, determine a merchant cash flow for the at least one identified merchant based at least on the historical transaction data and a scaling factor, and determine the estimate of the value of the real property location, based at least on the merchant cash flow, the merchant location data, and the historical transaction data.

In yet another aspect, a computer-readable storage medium having computer-executable instructions embodied thereon is provided. When executed by a computing device having at least one processor, the computer-executable instructions cause the computing device to receive merchant location data for at least one merchant, the merchant location data including data identifying a real property location where the at least one merchant is located, receive historical transaction data associated with the at least one merchant, receive an evaluation request message, the evaluation request message including data identifying the at least one merchant, determine a merchant cash flow for the at least one identified merchant based on the historical transaction data and a scaling factor, and determine an estimate of the value of the real property location, based at least on the merchant cash flow, the merchant location data, and the historical transaction data.

### BRIEF DESCRIPTION OF THE DRAWINGS

FIGS. 1-8 show example embodiments of the methods and systems described herein.

FIG. 1 is a schematic diagram illustrating an example multi-party payment card industry system for enabling ordinary payment-by-card transactions in which merchants and card issuers do not necessarily have a one-to-one relationship.

FIG. 2 is a simplified block diagram of an example pricing system including a plurality of computing devices in accordance with one example embodiment of the present disclosure.

FIG. 3 is an expanded block diagram of an example embodiment of a server architecture of the pricing system including the plurality of computing devices in accordance with one example embodiment of the present disclosure.

FIG. 4 illustrates an example configuration of a client system shown in FIGS. 2 and 3.

FIG. 5 illustrates an example configuration of a server system shown in FIGS. 2 and 3.

FIG. 6 is a block diagram of an example real property location.

FIG. 7 is a flowchart of an example process for estimating the value of the real property location shown in FIG. 6.

FIG. 8 is a diagram of components of one or more example computing devices that may be used in the pricing system shown in FIG. 2.

### DETAILED DESCRIPTION OF THE DISCLOSURE

Embodiments of the methods and systems described herein relate to estimating a value for a real property location and, more particularly, to computer systems and computer-based methods for estimating a value for a real property location based at least in part on historical transaction data of at least one merchant located at the real property location. In commercial real estate, the purchase price of a particular piece of real estate (a “real property location”) is based, in part, on the revenue (“cash flow”) that is generated by the real property location. For example, in a strip mall (also referred to as a “shopping center”), a rental price paid by the merchants operating stores in the strip mall is a key element in determining a fair purchase price for the strip mall. For example, the purchase price can be calculated as the combined rent of paid by the merchants over a year, divided by a “CAP” (short for “capitalization”) value that represents a desirability and safety of the neighborhood or area that the strip mall is located in. Even if an owner provides a potential purchaser of the strip mall with the terms of the lease agreements with each of the merchants operating in the strip mall, it is still unclear whether the merchants are and/or will continue to be able to meet their obligations under the lease agreement. In other words, although the lease terms may indicate a yearly revenue of, for example, 1.2 million dollars, it is possible that one or more of the merchants is not able to consistently pay the rent. Accordingly, simply combining the monthly rent from each merchant based on their lease terms does not accurately represent the revenue generated by the strip mall.

In addition to the above considerations regarding whether merchants in a strip mall can consistently pay their rent, other factors that affect the value of a strip mall include the risks of damage to the property due, for example, to the neighborhood the strip mall is located in and the types of goods and/or services that are sold by the merchants in the strip mall. For example, if one or more of the merchants is consistently receiving payments based on stolen payment cards (e.g., credit cards or debit cards), then it may be fair to conclude that the strip mall is located in a high-crime area and is likely to sustain damage due, for example, to vandalism. Additionally, if a merchant is selling highly-flammable, dangerous or explosive items, such as firecrackers or weapons, the risk of damage to the strip mall may be increased. The risk of damage to a strip mall is a key factor in calculating a premium for property insurance for the strip mall.

Embodiments of the systems and methods described herein receive location data for merchants, for example, when each merchant obtains a merchant account with a payment processing network and/or when a merchant relocates. Additionally, the systems and methods described herein generate historical transaction data based on payments processed through the payment network for each merchant. From the merchant location data, the systems and methods described herein determine that multiple merchants are located in the same real property location, for example a strip mall or other commercial real estate, and, based on the historical transaction information for each merchant, determine a value of the commercial real property location. The systems and methods described herein may make such a determination upon receiving a request to do so. In determining the value and providing information about the value in response to the request, some embodiments of the systems and methods described herein include information pertaining to (i) a purchase price for the real property location, (ii) a rental price paid by one or more merchants for the real property location, (iii) an assessment of the financial stability of one or more merchants, such as whether a merchant has a consistent cash flow and/or whether the cash flow is increasing, decreasing, or remaining constant, and/or (iv) information as to a likelihood of damage to the real property location.

While the description herein uses a strip mall as an example real property location, it should be understood that the systems and methods described herein would also work for other types of real property locations.

The methods and systems described herein may be implemented using computer programming or engineering techniques including computer software, firmware, hardware or any combination or subset thereof, wherein the technical effect may include at least one of: (a) receiving merchant location data for at least one merchant at a computing device, the merchant location data including data identifying a real property location where the at least one merchant is located, (b) receiving historical transaction data associated with the at least one merchant at the computing device, (c) receiving an evaluation request message at the computing device, the evaluation request message including data identifying the at least one merchant, (d) determining a merchant cash flow for the at least one identified merchant based at least on the historical transaction data and a scaling factor, and (e) determining an estimate of the value of the real property location, based at least on the merchant cash flow, the merchant location data, and the historical transaction data.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, smartphones, personal digital assistants (PDAs), key fobs, and/or computers. Each type of transactions card can be used as a method of payment for performing a transaction.

In one embodiment, a computer program is provided, and the program is embodied on a computer-readable medium. In an example embodiment, the system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to processing financial transaction data by a third party in industrial, commercial, and residential applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

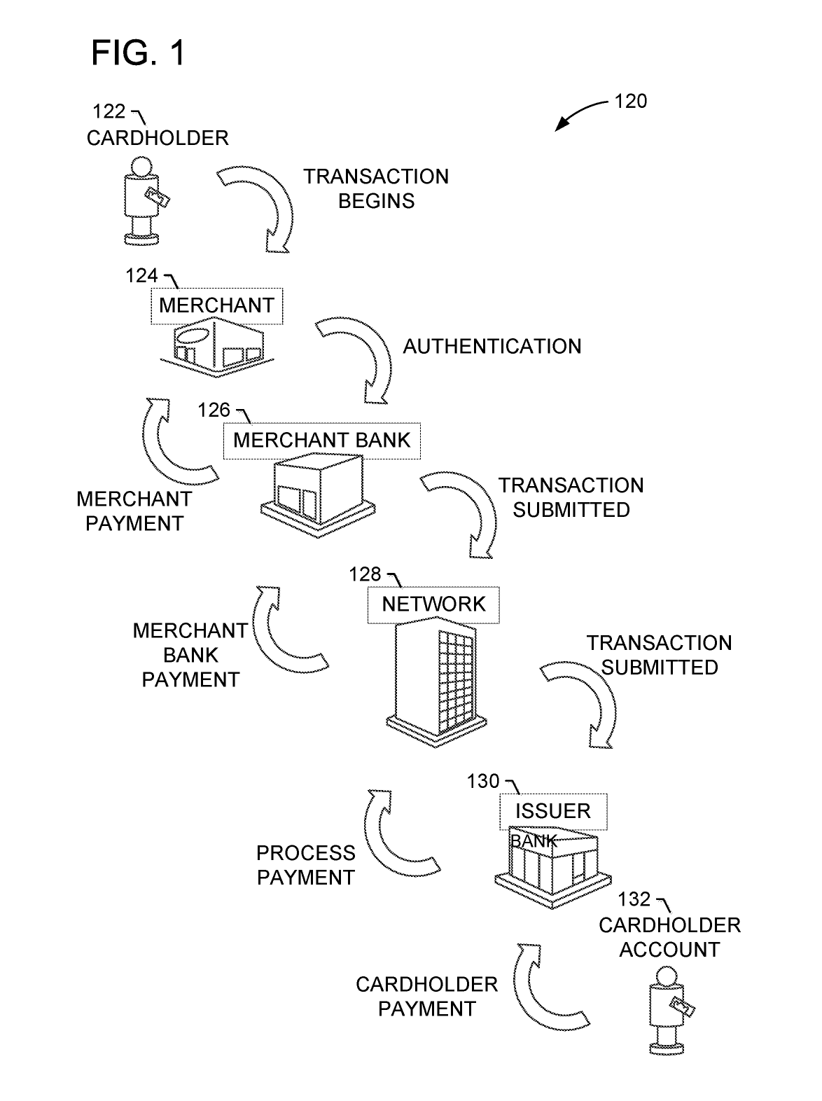

FIG. 1 is a schematic diagram illustrating an example multi-party payment card system 120 for enabling ordinary payment-by-card transactions in which merchants and card issuers do not necessarily have a one-to-one relationship. The present disclosure relates to payment card system 120, such as a credit card payment system using the MasterCard® payment card system payment network 128 (also referred to as an “interchange” or “interchange network”). MasterCard® payment card system payment network 128 is a proprietary communications standard promulgated by MasterCard International Incorporated® for the exchange of financial transaction data between financial institutions that are members of MasterCard International Incorporated®. (MasterCard is a registered trademark of MasterCard International Incorporated located in Purchase, N.Y.).

In payment card system 120, a financial institution such as an issuer 130 issues a payment account card, such as a credit card account or a debit card account, to a cardholder 122, who uses the payment account card to tender payment for a purchase from a merchant 124. To accept payment with the payment account card, merchant 124 must normally establish an account with a financial institution that is part of the financial payment system. This financial institution is usually called the “merchant bank” or the “acquiring bank” or “acquirer bank” or simply “acquirer”. When a cardholder 122 tenders payment for a purchase with a payment account card (also known as a financial transaction card), merchant 124 requests authorization from acquirer 126 for the amount of the purchase. The request may be performed over the telephone, but is usually performed through the use of a point-of-interaction terminal, which reads the cardholder's account information from the magnetic stripe on the payment account card and communicates electronically with the transaction processing computers of acquirer 126. Alternatively, acquirer 126 may authorize a third party to perform transaction processing on its behalf. In this case, the point-of-interaction terminal will be configured to communicate with the third party. Such a third party is usually called a “merchant processor” or an “acquiring processor.”

Using payment card system payment network 128, the computers of acquirer 126 or the merchant processor will communicate with the computers of issuer 130, to determine whether the cardholder's account 132 is in good standing and whether the purchase is covered by the cardholder's available credit line or account balance. Based on these determinations, the request for authorization will be declined or accepted. If the request is accepted, an authorization code is issued to merchant 124.

When a request for authorization is accepted, the available credit line or available balance of cardholder's account 132 is decreased. Normally, a charge is not posted immediately to a cardholder's account because bankcard associations, such as MasterCard International Incorporated®, have promulgated rules that do not allow a merchant to charge, or “capture,” a transaction until goods are shipped or services are delivered. When a merchant ships or delivers the goods or services, merchant 124 captures the transaction by, for example, appropriate data entry procedures on the point-of-interaction terminal. If a cardholder cancels a transaction before it is captured, a “void” is generated. If a cardholder returns goods after the transaction has been captured, a “credit” is generated.

For debit card transactions, when a request for authorization is approved by the issuer, the cardholder's account 132 is decreased. Normally, a charge is posted immediately to cardholder's account 132. The bankcard association then transmits the approval to the acquiring processor for distribution of goods/services, or information or cash in the case of an ATM.

After a transaction is captured, the transaction is settled between merchant 124, acquirer 126, and issuer 130. Settlement refers to the transfer of financial data or funds between the merchant's account, acquirer 126, and issuer 130 related to the transaction. Usually, transactions are captured and accumulated into a “batch,” which is settled as a group.

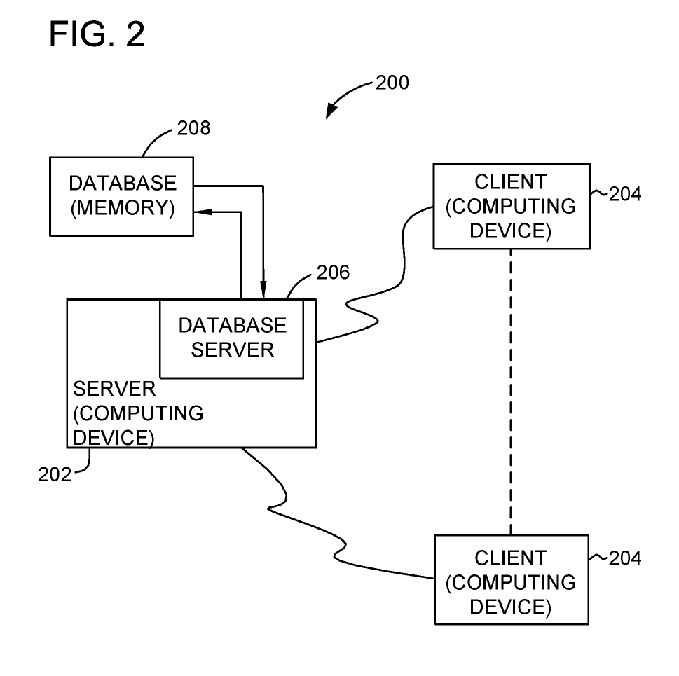

FIG. 2 is a simplified block diagram of an example pricing system 200 in accordance with one embodiment of the present disclosure. In the example embodiment, system 200 includes a server system 202 and a plurality of client subsystems, also referred to as client systems 204 or client computing devices, connected to server system 202. In one embodiment, client systems 204 are computers including a web browser, such that server system 202 is accessible to client systems 204 using the Internet. Client systems 204 are interconnected to the Internet through many interfaces including a network, such as a local area network (LAN) and/or a wide area network (WAN), dial-in connections, cable modems, wireless-connections, and special high-speed ISDN lines. Client systems 204 may be any device capable of interconnecting to the Internet including a web-based phone, personal digital assistant (PDA), or other web-connectable equipment. A database server 206 is connected to a database 208 containing information on a variety of matters, as described below in greater detail. In one embodiment, database 208 is stored on server system 202 and may be accessed by potential users at one of client systems 204 by logging onto server system 202 through one of client systems 204. In any alternative embodiment, database 208 is stored remotely from server system 202 and may be non-centralized. Server system 202 could be any type of computing device configured to perform the steps described herein.

As discussed below, historical payment card transaction data from merchants, including merchant account numbers, merchant locations, merchant names, transaction amounts, transaction dates, descriptions of goods or services sold, and fraud indicators for transactions that have been rejected due to fraud, is stored within database 208.

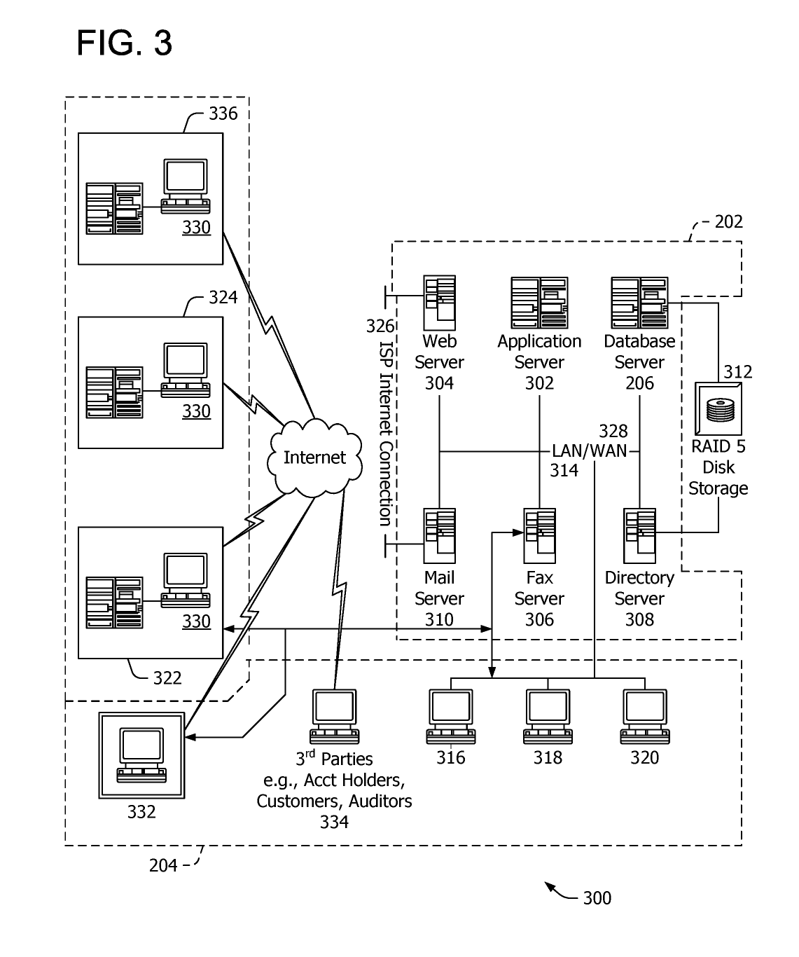

FIG. 3 is an expanded block diagram of an example embodiment of a server architecture of risk determination system 116 in accordance with one embodiment of the present disclosure. Risk detection system 116 includes server system 202 and client systems 204. Server system 202 further includes database server 206, an application server 302, a web server 304, a fax server 306, a directory server 308, and a mail server 310. A disk storage unit 312 is coupled to database server 206 and directory server 308. Servers 206, 302, 304, 306, 308, and 310 are coupled in a local area network (LAN) 314. In addition, a system administrator's workstation 316, a user workstation 318, and a supervisor's workstation 320 are coupled to LAN 314. Alternatively, workstations 316, 318, and 320 are coupled to LAN 314 using an Internet link or are connected through an Intranet.

Each workstation, 316, 318, and 320, is a personal computer having a web browser. Although the functions performed at the workstations typically are illustrated as being performed at respective workstations 316, 318, and 320, such functions can be performed at one of many personal computers coupled to LAN 314. Workstations 316, 318, and 320 are illustrated as being associated with separate functions only to facilitate an understanding of the different types of functions that can be performed by individuals having access to LAN 314.

Server system 202 is configured to be communicatively coupled to various entities, including acquirers 322 and issuers 324, and to third parties, e.g., auditors, 334 using an Internet connection 326. Server system 202 is also communicatively coupled with a merchant 336. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 328, local area network 314 could be used in place of WAN 328.

In the example embodiment, any authorized individual or entity having a workstation 330 may access system 300. At least one of the client systems includes a manager workstation 332 located at a remote location. Workstations 330 and 332 include personal computers having a web browser. Also, workstations 330 and 332 are configured to communicate with server system 202. Furthermore, fax server 306 communicates with remotely located client systems, including a client system 332, using a telephone link. Fax server 306 is configured to communicate with other client systems 316, 318, and 320 as well.

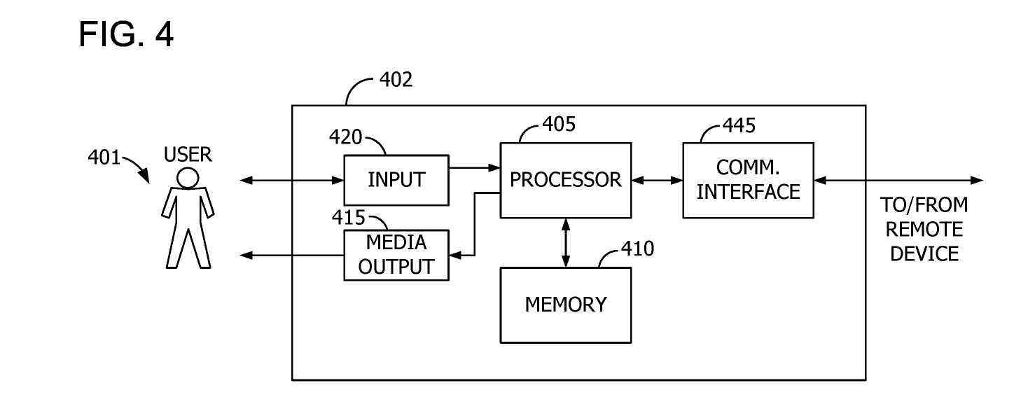

FIG. 4 illustrates an example configuration of a cardholder computing device 402 operated by a cardholder 401. Cardholder computing device 402 may include, but is not limited to, client systems (“client computing devices”) 204, 316, 318, and 320, workstation 330, and manager workstation 332 (shown in FIG. 3).

Cardholder computing device 402 includes a processor 405 for executing instructions. In some embodiments, executable instructions are stored in a memory area 410. Processor 405 may include one or more processing units (e.g., in a multi-core configuration). Memory area 410 is any device allowing information such as executable instructions and/or other data to be stored and retrieved. Memory area 410 may include one or more computer-readable media.

Cardholder computing device 402 also includes at least one media output component 415 for presenting information to cardholder 401. Media output component 415 is any component capable of conveying information to cardholder 401. In some embodiments, media output component 415 includes an output adapter such as a video adapter and/or an audio adapter. An output adapter is operatively coupled to processor 405 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, cardholder computing device 402 includes an input device 420 for receiving input from cardholder 401. Input device 420 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 415 and input device 420.

Cardholder computing device 402 may also include a communication interface 425, which is communicatively couplable to a remote device such as server system 202 or a web server operated by a merchant. Communication interface 425 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 410 are, for example, computer-readable instructions for providing a user interface to cardholder 401 via media output component 415 and, optionally, receiving and processing input from input device 420. A user interface may include, among other possibilities, a web browser and client application. Web browsers enable cardholders, such as cardholder 401, to display and interact with media and other information typically embedded on a web page or a website from server system 202 or a web server associated with a merchant. A client application allows cardholder 401 to interact with a server application from server system 202 or a web server associated with a merchant.

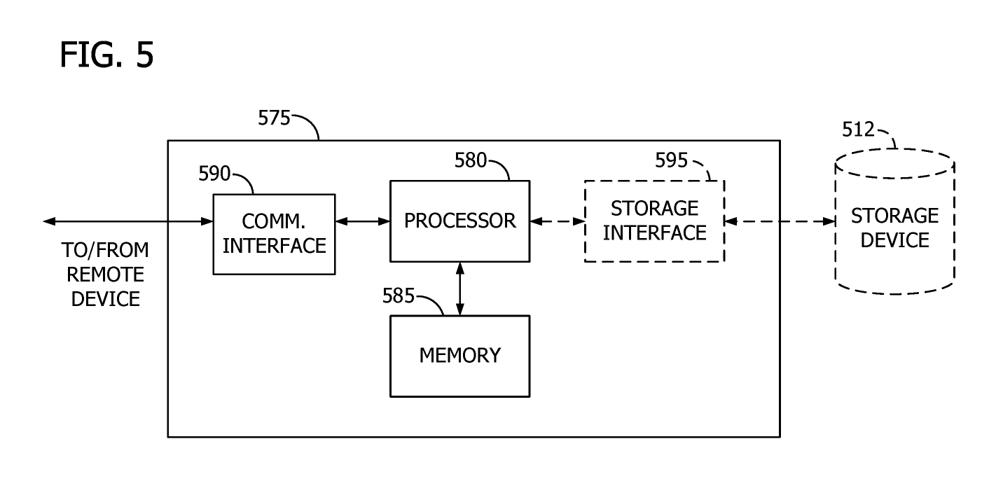

FIG. 5 illustrates an example configuration of a server computing device 575 such as server system 202 (shown in FIGS. 2 and 3). Server computing device 575 may include, but is not limited to, database server 206, application server 302, web server 304, fax server 306, directory server 308, and mail server 310.

Server computing device 575 includes a processor 580 for executing instructions. Instructions may be stored in a memory area 585, for example. Processor 580 may include one or more processing units (e.g., in a multi-core configuration).

Processor 580 is operatively coupled to a communication interface 590 such that server computing device 575 is capable of communicating with a remote device such as cardholder computing device 402 or another server computing device 575. For example, communication interface 590 may receive requests from client systems 204 via the Internet, as illustrated in FIGS. 2 and 3.

Processor 580 may also be operatively coupled to a storage device 512. Storage device 512 is any computer-operated hardware suitable for storing and/or retrieving data. In some embodiments, storage device 512 is integrated in server computing device 575. For example, server computing device 575 may include one or more hard disk drives as storage device 512. In other embodiments, storage device 512 is external to server computing device 575 and may be accessed by a plurality of server computing devices 575. For example, storage device 512 may include multiple storage units such as hard disks or solid state disks in a redundant array of inexpensive disks (RAID) configuration. Storage device 512 may include a storage area network (SAN) and/or a network attached storage (NAS) system.

In some embodiments, processor 580 is operatively coupled to storage device 512 via a storage interface 595. Storage interface 595 is any component capable of providing processor 580 with access to storage device 512. Storage interface 595 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 580 with access to storage device 512.

Memory areas 410 and 585 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

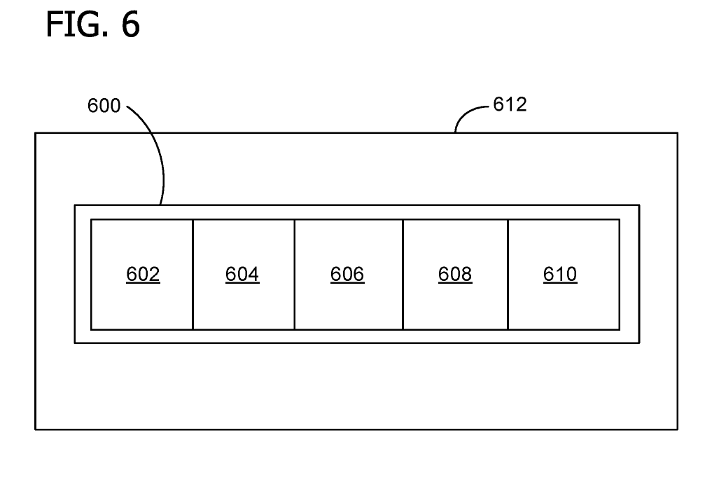

FIG. 6 is a block diagram of an example real property location 600. More specifically, real property location 600 is a commercial real estate property. Even more specifically, real property location 600 is a strip mall (also referred to as a “shopping center”) that includes a first merchant 602, a second merchant 604, a third merchant 606, a fourth merchant 608, and a fifth merchant 610. Real property location 600 is within a neighborhood 612. Each of merchants 602, 604, 606, 608, and 610 receive payments from one or more cardholders 22 (FIG. 1) for goods and/or services. The payments are processed through payment network 128 (FIG. 1), as described above. Accordingly, database 208 contains historical transaction data, including account numbers, locations, and names of merchants 602, 604, 606, 608, and 610, as well as transaction amounts, transaction dates, descriptions or codes representative of goods or services sold, and fraud indicators for transactions that have been rejected due to fraud (e.g., identity theft), for each of merchants 602, 604, 606, 608, and 610. By grouping merchants 602, 604, 606, 608, and 610 according to their location, server system 202 determines that merchants 602, 604, 606, 608, and 610 are all located in real property location 600. Additionally, by summing a total number of payments to each merchant 602, 604, 606, 608, and 610 processed by payment network 128 and multiplying the sum by a scaling factor that accounts for estimated payments received by checks, other payment card networks, and/or other forms of payment, server system 202 determines an estimated a monthly revenue (or “cash flow”) of each merchant 602, 604, 606, 608, and 610.

The scaling factor may be stored in database 208. In some implementations, the scaling factor may be based, at least in part, on a geographic region in which real property location 600 is located. For example, database 208 may store an indicator of market share for payment network 128 for each of multiple geographic regions, to facilitate calculating a scaling factor. Accordingly, if real property location 600 is in a first geographic region in which payment network 128 has a first market share, then the associated scaling factor is larger than if real property location 600 is in a second geographic region in which payment network 128 has a second market share that is greater than the first market share. In some implementations, a different scaling factor is associated with each merchant 602, 604, 606, 608, and 610 and may be based, at least in part, on a type of business of the merchant determined from the historical transaction data for the merchant. More specifically, goods and services associated with, for example, merchant 602 may be associated with a higher percentage of cash transactions than goods and services associated with merchant 604. Accordingly, the scaling factor associated with merchant 602 may be larger than the scaling factor associated with merchant 604.

Server system 202 may determine whether the estimated revenue for each merchant 602, 604, 606, 608, and 610 is trending upward, trending downward, or remaining constant over time. In some embodiments, server system 202 may additionally or alternatively determine whether revenue received by each merchant 602, 604, 606, 608, and 610 is consistent from month to month or if the revenue is inconsistent, and determine a stability score that represents a financial stability of each merchant 602, 604, 606, 608, and 610. That is, server system 202 may determine that there are spikes and gaps in a flow of revenue received by one or more of merchants 602, 604, 606, 608, and 610 over time. Using one or more of the above determinations, server system 202 may determine a success score, which represents whether each merchant 602, 604, 606, 608, and 610 is currently or is likely to be financially successful (i.e., obtain a predetermined financial condition). For example, server system 202 may determine that first merchant 602 is likely to be financially successful because first merchant 602 is associated with an estimated revenue that is trending upward and that there are no months in which first merchant 602 did not receive revenue. Accordingly, server system 202 may determine a likelihood, for example a score ranging from zero to ten, that first merchant 602 will reach a predetermined monthly revenue in a predetermined time period. Server system 202 may provide such determinations to, for example, an owner of real property location 600 and/or a potential purchaser of real property location 600.

Moreover, server system 202 may generate indicators that one or more of merchants 602, 604, 606, 608, and 610 represents an insurance risk for real property location 600. For example, server system 202 may store, in database 208, a list of terms for goods and/or services that represent a high risk of damage to real property location 600. The list may include, for example, fireworks, weapons, explosives, or other hazardous items. Server system 202 may search database 208 and determine whether one or more of merchants 602, 604, 606, 608, and 610 has a name that includes one or more of the terms and/or whether one or more of such terms appears in the transaction history for one or more of merchants 602, 604, 606, 608, and 610. Server system 202 may provide such indicators to, for example, an insurer of real property location 600 to aid in calculating an insurance premium.

In some embodiments, server system 202 may determine whether the neighborhood 612 in which real property location 600 is situated represents an insurance risk. For example, server system 202 may determine, from the historical transaction data in database 208 for one or more of merchants 602, 604, 606, 608, and 610, a number of transactions that have been rejected due to fraud. Server system 202 may assign real property location 600 a risk value of, for example, 0.05, if the number of transactions due to fraud in a predetermined time period (e.g., one year) is below a first predetermined threshold (e.g., three). Likewise, server system 202 may assign a risk value of, for example, 0.1, if the number of transactions is equal to or above the first threshold but below a second threshold (e.g., six), and so on. The number of predetermined thresholds, the predetermined time period, and the corresponding risk values to be assigned may differ in other embodiments. Server system 202 may provide such a risk determination to, for example, an insurer of real property location 600 to aid in calculating an insurance premium. Additionally or alternatively, in some embodiments, using the merchant location data, server system 202 may determine a turnover frequency for merchants at real property location 600, which may be another indicator of the desirability and/or safety of neighborhood 612 and/or of real property location 600 itself. Some or all of the above described information may be provided by server system 202 in the form of a risk score, which may be, for example, a number ranging from zero to ten.

Additionally, server system 202 may generate an estimated purchase price or value for real property location 600, for a potential purchaser to use in negotiations with an owner of real property location 600. Each of first merchant 602, second merchant 604, third merchant 606, fourth merchant 608, and fifth merchant 610 is obligated to pay a monthly rent in order to operate in real property location 600. The combined rent that merchants 602, 604, 606, 608, and 610 must pay each month, multiplied by twelve and divided by a CAP value provides an indication of the value of real property location 600 to a potential purchaser of real property location 600. Accordingly, the higher the CAP value, the lower the value of real property location 600. The CAP value represents, for example, the safety and reputation of neighborhood 612. Server system 202 may determine the CAP value based at least in part on the risk value calculated for insurance purposes, as described above. A higher risk value for insurance purposes corresponds to a higher CAP value, and likewise, a lower risk value corresponds to a lower CAP value.

An owner of real property location 600 may provide information to server system 202 regarding lease terms, for example a lease begin date and a lease end date, and a monthly rent required from each merchant 602, 604, 606, 608, and 610. In other embodiments, server system 202 may obtain the lease terms from another source, for example from a potential purchaser to whom the owner of real property location 600 has provided the lease terms. By comparing the estimated revenue of each merchant 602, 604, 606, 608, and 610 to the lease terms for each merchant 602, 604, 606, 608, and 610, server system 202 may determine whether each merchant 602, 604, 606, 608, and 610 is financially able to pay the rent required under the lease. Server system 202 may provide such a determination to the owner of real property location 600 to aid the owner in deciding whether to renew the lease with one or more of merchants 602, 604, 606, 608, and 610. Additionally, or alternatively, server system 202 may provide the determination to a potential purchaser of real property location 600 to aid the potential purchaser in calculating a purchase price for real property location 600.

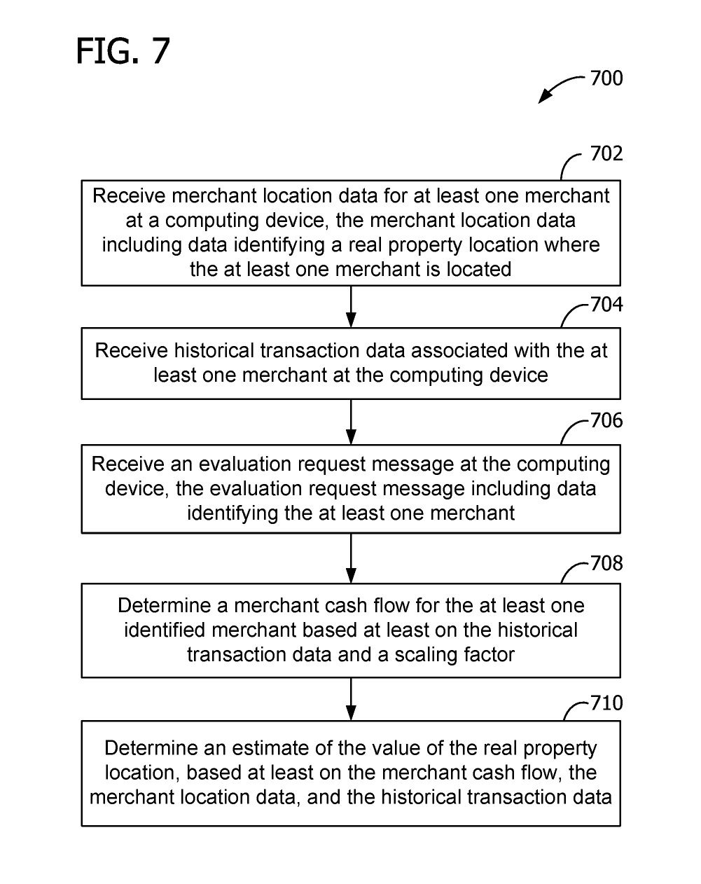

FIG. 7 is a flowchart of an example process 700 for estimating the value of real property location 600 (FIG. 6). Initially, server system 202 receives 702 merchant location data for at least one merchant 602, 604, 606, 608, and 610. The merchant location data may be provided by the at least one merchant 602, 604, 606, 608, and 610 to server system 202 for storage in database 208 when the at least one merchant 602, 604, 606, 608, and 610 establishes an account with payment network 128 through an acquirer bank 126 and/or when the merchant relocates. Server system 202 requests and receives the merchant location data from database 208 on an as-needed basis. The merchant location data includes data identifying the real property location where each merchant 602, 604, 606, 608, and 610 is located. Next, server system 202 receives 704 the historical transaction data associated with the at least one merchant. Server system 202 receives and stores the historical transaction data over time, as each merchant 602, 604, 606, 608, and 610 receives payments from cardholders using payment network 128. Server system 202 requests and receives the historical transaction data from database 208 on an as-needed basis.

Next, server system 202 receives 706 an evaluation request message. The evaluation request message may be received from, for example, a potential purchaser of real property location 600. In other embodiments, the evaluation request message may be received from the owner of real property location 600, an insurer of real property location 600, or another entity. The evaluation request message is transmitted to server system 202 by a client system 204 (FIG. 2). The evaluation request message includes data identifying the at least one merchant 602, 604, 606, 608, and 610. For example, the evaluation request message may identify the merchant by location and/or name. In some embodiments, the evaluation request message identifies one merchant, while in other embodiments, the evaluation request may identify multiple merchants. In some embodiments, the evaluation request may additionally include a time period that the evaluation request is to be based on. If the evaluation request message does specify such a time period, server system 202 restricts the determinations in the following steps to the specified time period.

Next, server system 202 determines 708 a merchant cash flow (i.e., estimated revenue) for the at least one identified merchant 602, 604, 606, 608, and 610 based at least on the historical transaction data and a scaling factor. As described above, the historical transaction data is stored in database 208 and includes payments for each merchant 602, 604, 606, 608, and 610 that have been processed through payment network 128. Given that each merchant 602, 604, 606, 608, and 610 likely receives payments in other manners as well, server system 202 applies a scaling factor to the payment amounts in the historical transaction data to arrive at an estimated revenue for each merchant 602, 604, 606, 608, and 610. For example, if payment network 128 processes 25 percent of payments received by merchants in general, then server system 202 multiplies the payment amounts shown in the historical transaction data by a scaling factor of four.

Next, server system 202 determines 710 an estimate of the value of real property location 600 based at least on the merchant cash flow, the merchant location data, and the historical transaction data. More specifically, in one embodiment, server system 202 multiplies a monthly rent associated with each merchant 602, 604, 606, 608, and 610 by twelve and divides the result by a CAP value, as described with reference to FIG. 6. Additionally, server system 202 may include in the value determination a determination of a rental price for real property location 600. In some embodiments, server system 202 additionally includes in the estimated value determination one or more scores representing one or more of whether each merchant 602, 604, 606, 608, and 610 has an estimated revenue that is trending upward, trending downward, or remaining constant, a consistency of the revenue of each merchant 602, 604, 606, 608, and 610, a determination that each merchant 602, 604, 606, 608, and 610 is or is likely to be financially successful (i.e., obtain a predetermined financial condition), and whether each merchant 602, 604, 606, 608, and 610 is able to pay the rent associated with real property location 600. Additionally, server system 202 may provide a score or indication of a level of insurance risk and/or an insurance premium for real property location 600 based on goods and/or services sold by each merchant 602, 604, 606, 608, and 610 and/or a score based on a number of transactions that have been rejected in payment network 128 due to fraud.

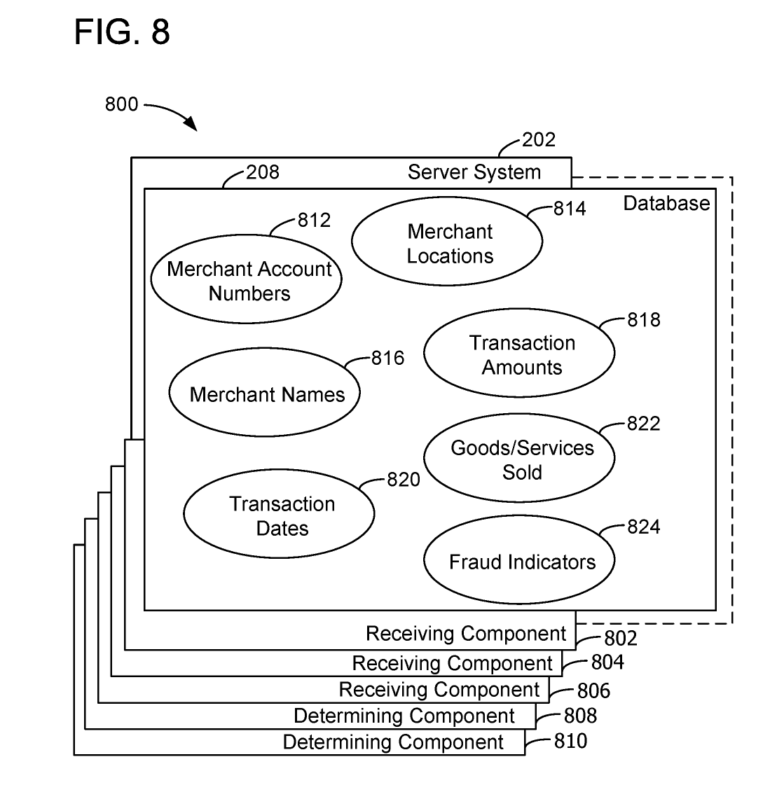

FIG. 8 is a diagram 800 of components of one or more example computing devices, for example, server system 202, that may be used in embodiments of the described systems and methods. FIG. 8 further shows a configuration of database 208 (FIG. 2). Database 208 is coupled to several separate components within server system 202, which perform specific tasks.

Server system 202 includes a receiving component 802 for receiving merchant location data for at least one merchant 602, 604, 606, 608, and 610, wherein the merchant location data includes data identifying a real property location, for example real property location 600, where each merchant 602, 604, 606, 608, and 610 is located. Server system 202 also includes a receiving component 804 for receiving historical transaction data associated with the at least one merchant 602, 604, 606, 608, and 610. Server system 202 additionally includes a receiving component 806 for receiving an evaluation request message. The evaluation request message includes data identifying the at least one merchant 602, 604, 606, 608, and 610. Server system 202 additionally includes a determining component 808 for determining a merchant cash flow (i.e., revenue) for the at least one identified merchant 602, 604, 606, 608, and 610 based at least on the historical transaction data and a scaling factor. Additionally, server system 202 includes a determining component 810 for determining an estimate of the value of real property location 600, based at least on the merchant cash flow, the merchant location data, and the historical transaction data.

In an example embodiment, database 208 is divided into a plurality of sections, including but not limited to, a merchant account numbers section 812, a merchant locations section 814, a merchant names section 816, a transaction amounts section 818, a transaction dates section 820, a goods and services sold section 822 containing descriptions of and/or codes corresponding to goods and/or services sold by merchants 602, 604, 606, 608, and 610 in payments processed by payment network 128, and a fraud indicators section 824 containing flags or other indicators for transactions that have been rejected due to identity theft or other types of fraud. These sections within databases 208 are interconnected to retrieve and store information in accordance with the functions and processes described above.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 205, 305, including RAM memory, ROM memory, EPROM memory, EEPROM memory, and non-volatile RAM (NVRAM) memory. The above memory types are example only, and are thus not limiting as to the types of memory usable for storage of a computer program.

As will be appreciated based on the foregoing specification, the above-discussed embodiments of the disclosure may be implemented using computer programming or engineering techniques including computer software, firmware, hardware or any combination or subset thereof. Any such resulting computer program, having computer-readable and/or computer-executable instructions, may be embodied or provided within one or more computer-readable media, thereby making a computer program product, i.e., an article of manufacture, according to the discussed embodiments of the disclosure. These computer programs (also known as programs, software, software applications or code) include machine instructions for a programmable processor, and can be implemented in a high-level procedural and/or object-oriented programming language, and/or in assembly/machine language. As used herein, the terms “machine-readable medium,” “computer-readable medium,” and “computer-readable media” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium,” “computer-readable medium,” and “computer-readable media,” however, do not include transitory signals (i.e., they are “non-transitory”). The term “machine-readable signal” refers to any signal used to provide machine instructions and/or data to a programmable processor.

The above-described embodiments of a method and system of estimating a value for a real property location provide information to potential purchasers of commercial real estate, owners of commercial real estate, and insurers of commercial real estate financial information that would otherwise be difficult or impossible to obtain. More specifically, the methods and systems described herein facilitate determining, for example, a purchase price of commercial real estate, a cash flow of merchants located in the commercial real estate, an ability of the merchants to pay rent, and risk information for calculating insurance premiums for commercial real estate. As a result, the methods and systems described herein enable entities involved in commercial real estate to more accurately understand the value of a real property location. It should be understood that certain embodiments of the disclosure may be used to estimate values for real property locations other than strip malls, for example, public storages, motels, hotels, parking lots, and franchise stores.

This written description uses examples, including the best mode, to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1-20. (canceled)

21. A computer-implemented method for evaluating a physical commercial site, said method implemented by at least one server associated with a payment card interchange network, the at least one server including at least one processor in communication with a database, said method comprising:
storing, in the database, merchant location data for a plurality of merchants each having merchant accounts with the payment card interchange network;
processing, by the at least one processor, transaction authorization messages submitted by the plurality of merchants over the payment card interchange network, the transaction authorization messages formatted using a proprietary communications standard promulgated by the payment card interchange network;
storing, by the at least one processor in the database, historical transaction data derived from the processed transaction authorization messages;
receiving, by the at least one processor, an evaluation request message from a client computing device, the evaluation request message including information associated with at least one merchant of the plurality of merchants, the at least one merchant operating at the physical commercial site;
retrieving, by the at least one processor from the merchant location data in the database, a subset of the plurality of merchants operating at the physical commercial site;
calculating, by the at least one processor from the historical transaction data in the database, a total amount of payments processed by the payment card interchange network for each merchant of the subset over a time period of interest;
estimating, by the at least one processor, a merchant cash flow for each merchant of the subset by applying to the total amount of payments a scaling factor representing an amount of usage of the payment card interchange network in a geographical area where the physical commercial site is located;
determining, by the at least one processor, an estimated value of the physical commercial site based on the estimated merchant cash flow for each merchant of the subset; and
transmitting the estimated value to the client computing device.

22. The computer-implemented method of claim 21, further comprising:
generating, by the at least one processor for each merchant in the subset, a plurality of scores based on the merchant cash flow for the respective merchant, wherein the plurality of scores includes at least one of a revenue trend score, a revenue consistency score, a financial success score, a rent payment ability score, and an insurance risk score; and
transmitting the plurality of scores to the client computing device.

23. The computer-implemented method of claim 22, wherein generating the plurality of scores further comprises:
determining, by the at least one processor for each merchant of the subset, a first revenue during a first month and a second revenue during a second month, wherein the second month is contiguous in time with the first month;
calculating, by the at least one processor, a difference between the first revenue and the second revenue; and
determining the revenue consistency score based on the calculated difference.

24. The computer-implemented method of claim 22, wherein the financial success score represents a probability that the respective merchant will achieve a predetermined monthly revenue level.

25. The computer-implemented method of claim 22, wherein generating the plurality of scores further comprises calculating the rent payment ability score based on a comparison between the historical transaction data and lease data associated with the respective merchant.

26. The computer-implemented method of claim 22, wherein generating the plurality of scores further comprises:
determining, for each merchant of the subset from the historical transaction data, a number of payment transactions at the merchant processed over the payment card interchange network rejected due to fraud; and
calculating the insurance risk score for each merchant based on the number of rejected transactions.

27. The computer-implemented method of claim 21, wherein receiving the evaluation request message comprises receiving the evaluation request message identifying a name of a shopping center at the physical commercial site.

28. The computer-implemented method of claim 21, wherein receiving the evaluation request message comprises receiving a time period selection identifying the time period of interest.

29. A computing system for evaluating a physical commercial site, the computing system comprising at least one server associated with a payment card interchange network, said at least one server including at least one processor in communication with a database, said at least one server configured to:
store, in the database, merchant location data for a plurality of merchants each having merchant accounts with the payment card interchange network;
process transaction authorization messages submitted by the plurality of merchants over the payment card interchange network, the transaction authorization messages formatted using a proprietary communications standard promulgated by the payment card interchange network;
store, in the database, historical transaction data derived from the processed transaction authorization messages;
receive an evaluation request message from a client computing device, the evaluation request message including information associated with at least one merchant of the plurality of merchants, the at least one merchant operating at the physical commercial site;
retrieve, from the merchant location data in the database, a subset of the plurality of merchants operating at the physical commercial site;
calculate, from the historical transaction data in the database, a total amount of payments processed by the payment card interchange network for each merchant of the subset over a time period of interest;
estimate a merchant cash flow for each merchant of the subset by applying to the total amount of payments a scaling factor representing an amount of usage of the payment card interchange network in a geographical area where the physical commercial site is located;
determine an estimated value of the physical commercial site based on the estimated merchant cash flow for each merchant of the subset; and
transmit the estimated value to the client computing device.

30. The computing system of claim 29, wherein said at least one server is further configured to:
generate, for each merchant in the subset, a plurality of scores based on the merchant cash flow for the respective merchant, wherein the plurality of scores includes at least one of a revenue trend score, a revenue consistency score, a financial success score, a rent payment ability score, and an insurance risk score; and
transmit the plurality of scores to the client computing device.

31. The computing system of claim 30, wherein said at least one server is further configured to:
determine, for each merchant of the subset, a first revenue during a first month and a second revenue during a second month, wherein the second month is contiguous in time with the first month;
calculate, by the at least one processor, a difference between the first revenue and the second revenue; and
determine the revenue consistency score based on the calculated difference.

32. The computing system of claim 30, wherein the financial success score represents a probability that the respective merchant will achieve a predetermined monthly revenue level.

33. The computing system of claim 30, wherein said at least one server is further configured to calculate the rent payment ability score based on a comparison between the historical transaction data and lease data associated with the respective merchant.

34. The computing system of claim 30, wherein said at least one server is further configured to:
determine, for each merchant of the subset from the historical transaction data, a number of payment transactions at the merchant processed over the payment card interchange network rejected due to fraud; and
calculate the insurance risk score for each merchant based on the number of rejected transactions.

35. The computing system of claim 29, wherein said at least one server is further configured to: receive the evaluation request message identifying a name of a shopping center at the physical commercial site.

36. The computing system of claim 29, wherein said at least one server is further configured to receive the evaluation request message specifying a time period selection identifying the time period of interest.

37. A non-transitory computer-readable storage medium having computer-executable instructions embodied thereon for evaluating a physical commercial site, wherein when executed by at least one server associated with a payment card interchange network and having at least one processor in communication with a database, the computer-executable instructions cause the at least one processor to:
store, in the database, merchant location data for a plurality of merchants each having merchant accounts with the payment card interchange network;
process transaction authorization messages submitted by the plurality of merchants over the payment card interchange network, the transaction authorization messages formatted using a proprietary communications standard promulgated by the payment card interchange network;
store, in the database, historical transaction data derived from the processed transaction authorization messages;
receive an evaluation request message from a client computing device, the evaluation request message including information associated with at least one merchant of the plurality of merchants, the at least one merchant operating at the physical commercial site;
retrieve, from the merchant location data in the database, a subset of the plurality of merchants operating at the physical commercial site;
calculate, from the historical transaction data in the database, a total amount of payments processed by the payment card interchange network for each merchant of the subset over a time period of interest;
estimate a merchant cash flow for each merchant of the subset by applying to the total amount of payments a scaling factor representing an amount of usage of the payment card interchange network in a geographical area where the physical commercial site is located;
determine an estimated value of the physical commercial site based on the estimated merchant cash flow for each merchant of the subset; and
transmit the estimated value to the client computing device.

38. The non-transitory computer-readable storage medium of claim 37, wherein the computer-executable instructions further cause the at least one processor to:
generate, for each merchant in the subset, a plurality of scores based on the merchant cash flow for the respective merchant, wherein the plurality of scores includes at least one of a revenue trend score, a revenue consistency score, a financial success score, a rent payment ability score, and an insurance risk score; and
transmit the plurality of scores to the client computing device.

39. The non-transitory computer-readable storage medium of claim 38, wherein the computer-executable instructions further cause the at least one processor to:
determine, for each merchant of the subset, a first revenue during a first month and a second revenue during a second month, wherein the second month is contiguous in time with the first month;
calculate, by the at least one processor, a difference between the first revenue and the second revenue; and
determine the revenue consistency score based on the calculated difference.

40. The non-transitory computer-readable storage medium of claim 38, wherein the computer-executable instructions further cause the at least one processor to:
determine, for each merchant of the subset from the historical transaction data, a number of payment transactions at the merchant processed over the payment card interchange network rejected due to fraud; and
calculate the insurance risk score for each merchant based on the number of rejected transactions.
